(19) United States
(12) Patent Application Publication
(10) Pub. No.: US 2024/0141951 A1
(43) Pub. Date: May 2, 2024

(54) HINGED JOINT AND METHOD OF USE

(71) Applicant: LEISURELIFE (AUST.) PTY. LTD., Hawthorn East Victoria (AU)

(72) Inventor: Maxwell William DAY, Victoria (AU)

(73) Assignee: LEISURELIFE (AUST.) PTY. LTD., Hawthorn East Victoria (AU)

(21) Appl. No.: 18/282,210

(22) PCT Filed: Mar. 2, 2022
(86) PCT No.: PCT/AU2022/050165

§ 371 Date: Sep. 14, 2023

(30) Foreign Application Priority Data
Mar. 16, 2021 (AU) 2021900758
Mar. 17, 2021 (AU) 2021900772

(51) Int. Cl. F16C 11/10

(52) U.S. Cl. CPC F16C 11/10; E04H 15/48

(57) ABSTRACT

A hinged joint is described for connecting an outer housing frame member to an inner housing frame member, the hinged joint comprising an outer housing associated with the outer housing frame member, the outer housing having an elongate seat disposed between opposing side walls, and a hinge pin supported by each of said side walls; an inner housing associated with an inner housing frame member, the inner housing being at least partially receivable on the elongate seat of the outer housing, the hinge pin being operatively locatable in a hinge pin guide of the inner housing, the hinge pin guide having a locking guide part and an unlocking guide part, wherein movement of the outer housing is in association with movement of the hinge pin in the hinge guide of the inner housing. Frames comprising a plurality of frame members connected by the hinged joint are also described.

### FIELD OF INVENTION

The present invention relates to a device for connecting frame members in a hinged relationship.

In one form, the invention relates to a joint for a frame that can be rapidly folded and unfolded. In one particular form, the invention relates to a device for connecting frame members of a self-supporting structure such as a tent, a marquee or an awning. In another form, the invention relates to a joint for a prop, such as a support for a shade umbrella.

It will be convenient to hereinafter describe the invention in relation to tent frames, however it should be appreciated that the present invention is not so limited and can be used in a wide range of applications.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

A wide range of self-supporting structures include jointed frame members. For example, tents, marquees and awnings typically include a number of elongate frame members that are interconnected by various devices to form a structure for supporting a fabric.

Tents are self-supporting structures that are generally collapsed or dismantled prior to being stored or transported to a new site for re-assembly. Some tents have a dome shaped frame comprising a hub and spokes that is raised and collapsed in a similar fashion to an umbrella.

Some tents are dismantled by reducing the frame to individual elements or groups of elements that can be readily packed for storage or transport. This may involve joints connecting two or more frame members.

The frame may, for example, comprise multiple elongate members such as poles with multiple joints therebetween which work together to maintain the tent in an assembled, self-supporting condition. Joints of this type are typically self-locking, comprise many parts and are expensive to manufacture. Furthermore, locking joints generally require two hands to lock and unlock. This can make it slow and awkward for a user to raise or collapse these kinds of tents.

Hinged joints of this type need to be sufficiently robust to maintain the integrity of the frame during the time it is self-supporting. This includes being strong enough to hold elongate members together and contribute to supporting the tent fabric. Importantly during use the hinged joints need to be easily and securely locked so that they hold the elongate members in the desired position. During disassembly, they need to be readily unlocked and bent (‘cracked’) so that the elongate members can be folded together.

The cost of the various components employed in the tent construction is an important consideration. That is, both the initial cost for the parts themselves and their assembly must be reasonable in order to provide a realistic price point for a manufacturer, and the easy and cost-effective replacement of parts of the tent frame, which may become damaged in use.

There remains a need for improved light-weight components such as joints for self-supporting frame members for a collapsible shelter or tent. There is also a need for joints that are of simple construction and convenient to use when raising, collapsing and repackaging the frame into a compact shape and size for storage. There is also a need for a joint for a collapsible shelter which is relatively cost-effective to manufacture.

### SUMMARY OF INVENTION

An object of the present invention is to provide a joint for elongate frame members that can be readily locked and unlocked.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

Broadly, the invention provides a hinged joint comprising an inner housing nestled within an outer housing and operatively connected by a hinge pin constrained in travel within a generally arc-shaped hinge pin guide.

In a first aspect of embodiments described herein there is provided a hinged joint for connecting an outer housing frame member to an inner housing frame member, the hinged joint comprising:
an outer housing associated with the outer housing frame member, the outer housing having an elongate seat disposed between opposing side walls, and a hinge pin supported by each of said side walls;
an inner housing associated with an inner housing frame member, the inner housing being at least partially receivable on the elongate seat of the outer housing, the hinge pin being operatively locatable in a hinge pin guide of the inner housing, the hinge pin guide having a locking guide part and an unlocking guide part;
wherein movement of the outer housing is in association with movement of the hinge pin in the hinge guide of the inner housing.

In another characterisation of embodiments described herein there is provided a hinged joint for connecting a first frame member to a second frame member, the hinged joint comprising:
a first housing associated with the first frame member, the first housing having an elongate seat disposed between opposing side walls, and a hinge pin supported by each of said side walls;
a second housing associated with a second frame member, the second housing being at least partially receivable on the elongate seat of the first housing, the hinge pin being operatively locatable in a hinge pin guide of the second housing, the hinge pin guide having a first guide part and a second guide part,
wherein movement of the first housing is in association with movement of the hinge pin in the hinge guide of the second housing.

The hinge pin is supported by each of the walls of the outer housing. Typically the outer housing is elongate, having a longitudinal axis, with one wall located to the right of the longitudinal axis and the other wall located to the left of the longitudinal axis. Other references to ‘left’ and ‘right’ also indicate positions relative to the longitudinal axis. Typically, one end of the hinge pin is received in an operably right pivot mounting in an operably right wall, and the other end of the hinge pin is received in an operably left pivot mounting in an operably left wall. When the hinge joint is assembled and the inner housing sits on the elongate seat of the outer housing, the hinge pin also passes through the hinge pin guide of the inner housing. In this manner the outer housing is operatively jointed to the inner housing.

The hinge pin guide comprises two guide parts. In a preferred embodiment the hinge pin guide comprises a locking guide part and an unlocking guide part which are joined at an angle. Typically, the hinge pin resides adjacent an end of the locking guide part when the hinge is in a locked condition, and adjacent an end of the unlocking guide part when the hinge joint is in a collapsed condition. Preferably the two hinge pin guides join to form an arc-shaped hinge pin guide, having a generally L-, V- or C-shape. The confluence of the two hinge pin guides (i.e. the apex of the L-, V- or C-shape) forms a pivot point during movement of the hinge joint. Specifically, when folding of the hinge joint is initiated the hinge pin is guided to the confluence of the two guides, which is effectively, an angled rest point about which the hinge pin pivots, allowing the joint to fold into the folded condition.

Preferably the inner housing is elongate, having a longitudinal axis and the hinge pin guide comprises an arc-shape recess or aperture formed transversely through the inner housing.

The outer housing has an elongate seat disposed between opposing side walls, and in a preferred embodiment has a shoulder integral with the seat. The shoulder is shaped to receive a hook on the inner housing.

Preferably the frame members are elongate frame members such as poles. Typically, a frame member is associated with a housing by being received in a channel in the housing and held by interference fit or any other convenient means.

Preferably the inner housing includes at least one locking lug, preferably two locking lugs, each lug disposed on either side of the inner housing and configured to be at least partially received in a corresponding locking recess of the outer housing. Typically, each locking recess of the inner housing is associated with a ramp. When the hinge is opened, the lug slides along the ramp inside the outer housing and drops into the locking recess. The ramp is profiled to aid a seamless movement without impairing the folding or unfolding sequence. The locking lugs longitudinally align the outer and inner housings to ensure the joint correctly drops into its locked condition.

In another aspect of embodiments described herein there is provided a hinged joint for connecting an outer housing frame member to an inner housing frame member, the hinged joint having:
(a) an outer housing comprising;
   an outer housing channel for receiving the outer housing frame member,
   an elongate seat, the seat having opposed side walls and a hook-receiving shoulder therebetween,
   at least one locking recess, preferably located adjacent an end of a side wall,
   an operably right pivot mounting and an operably left pivot mounting disposed on each of the side walls;
(b) an elongate inner housing having a longitudinal axis and being at least partially receivable on the elongate seat, the inner housing comprising;
   an inner housing channel for receiving the inner housing frame member,
   a hook adjacent an end of the inner housing, the hook adapted to be received on the shoulder of the outer housing,
   a curved hinge pin guide having a locking guide part and an unlocking guide part,
   at least one locking lug disposed on an outer surface of the inner housing and configured to be at least partially received in the at least one locking recess of the outer housing; and
(c) a hinge pin receivable in the operably right pivot mounting, operably left pivot mounting and the hinge pin guide when the inner housing is located in the elongate seat of the outer housing, such that the outer housing is operatively jointed to the inner housing.

In another aspect of embodiments described herein there is provided a hinged joint for connecting a first frame member to a second frame member, the hinged joint having:
(a) a first housing comprising;
   a first channel for receiving the first frame member,
   an elongate seat, the seat having opposed side walls and a hook-receiving shoulder therebetween,
   at least one locking recess, preferably located adjacent an end of a side wall,
   a first pivot mounting and a second pivot mounting disposed on each of the side walls;
(b) an elongate second housing having a longitudinal axis and being at least partially receivable on the elongate seat, the second housing comprising;
   a second channel for receiving the second frame member,
   a hook adjacent an end of the second housing, the hook adapted to be received on the shoulder of the first housing,
   a curved hinge pin guide having a first guide part and a second guide part,
   at least one locking lug disposed on an outer surface of the second housing and configured to be at least partially received in the at least one locking recess of the first housing; and
(d) a hinge pin receivable in the first pivot mounting, second pivot mounting and the hinge pin guide when the second housing is located in the elongate seat of the first housing, such that the first housing is operatively jointed to the second housing.

In a further aspect of the present invention there is provided;
a frame comprising a plurality of frame members, including at least one pair of elongate frame members in co-axial arrangement and connected by a hinged joint according to the present invention; and
wherein the frame can move between a self-supporting condition in which the hinged joint is in an open condition and a folded condition wherein the hinged joint is in a folded condition and the at least one pair of frame members are folded.

In a further aspect of embodiments described herein there is provided a method of moving the jointed hinge of the present invention between an open condition and a folded condition, the method comprising the steps of;
applying manual pressure on the outer housing transversely toward the inner housing to cause the hinge pin to slide within the locking guide part towards the unlocking guide part; and
rotating the inner housing around the hinge pin to move the hinge pin into the unlocking guide part, disengage the hook from the shoulder of the outer housing, and move the at least one lug out of the at least one locking recess.

In yet a further aspect of embodiments described herein there is provided a method of moving the jointed hinge of the present invention between a folded condition and an open condition, the method comprising the steps of;
rotating the inner housing around the hinge pin to slide the hinge pin within the unlocking guide part towards the locking guide part; and
sliding the hinge pin from the unlocking guide part into the locking guide part, to engage the hook on the shoulder of the inner housing and locate the at least one lug in the at least one locking recess.

In yet a further aspect of embodiments described herein there is provided a kit comprising the jointed hinge of the present invention.

In another aspect of embodiments described herein there is provided a kit comprising
(a) an outer housing comprising;
   an outer housing channel for receiving the outer housing frame member,
   an elongate seat, the seat having opposed side walls and a hook-receiving shoulder therebetween,
   at least one locking recess, preferably located adjacent an end of a side wall,
   an operably right pivot mounting and an operably left pivot mounting disposed on each of the side walls;
(b) an elongate inner housing having a longitudinal axis and being at least partially receivable on the elongate seat, the inner housing comprising;
   an inner housing channel for receiving the inner housing frame member,
   a hook adjacent an end of the inner housing, the hook adapted to be received on the shoulder of the outer housing,
   a curved hinge pin guide having a locking guide part and an unlocking guide part,
   at least one locking lug disposed on an outer surface of the inner housing and configured to be at least partially received in the at least one locking recess of the outer housing; and
(c) a hinge pin receivable in the operably right pivot mounting, operably left pivot mounting and the hinge pin guide when the inner housing is located in the elongate seat of the outer housing, such that the outer housing is operatively jointed to the inner housing;
(d) wherein the outer housing, the elongate inner housing, and the hinge pin are capable of assembly into a hinged joint for connecting an outer housing frame member to an inner housing frame member.

Other aspects and preferred forms are disclosed in the specification and/or defined in the appended claims, forming a part of the description of the invention.

In essence, embodiments of the present invention stem from the realization that the operation of a hinge configuration can be improved by altering the path of the pivot using a face cam. Specifically, it has been realised that using a non-linear hinge pin guide having a locking guide part and an unlocking guide part and providing a pivot point can better facilitate movement between a folded and open condition.

Advantages provided by the present invention comprise the following:
the hinge joint mechanism can be readily changed between the open and folded configurations using one hand;
the opening and folding operations put less pressure on the hinge;
the invention is easy to use and the requirement for less pressure means the hinge can be operated with one hand;
mechanical assists, such as springs, and secondary moving parts are not required for operation of the joint;
cost-effective to manufacture of inexpensive materials and relatively less material than hinges of the prior art;
hinge parts are of simple design, with relative few moving parts so the hinge joint can be easily assembled and disassembled;
reliable operation, moving instantly and consistently each time without jamming or missing connections;
light weight for easy handling;
clean design and with aesthetic appearance;
components having smooth shapes with no protrusions likely to catch on any fabric covering;
strong, providing stability;
when used in a frame, can withstand the elements, such as buffeting wind;
when used in a frame, sufficiently robust to be moved when the frame is fully assembled.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates the outer housing in perspective view wherein the longitudinal axis of the outer housing is parallel to the X-axis;

FIG. 2 illustrates the outer housing of FIG. 1 in side view, viewed in the direction of the Z-axis;

FIG. 3 illustrates the outer housing of FIG. 1 in longitudinal cross section;

FIG. 4 illustrates an end of the outer housing of FIG. 1 viewed along the X-axis;

FIG. 5 illustrates the outer housing of FIG. 1 viewed from underneath in the direction of the Y-axis;

FIG. 6 illustrates the inner housing in perspective view, wherein the longitudinal axis of the inner housing is parallel to the X-axis;

FIG. 7 illustrates the inner housing of FIG. 6 in side viewed in the direction of the Z-axis;

FIG. 8 illustrates the inner housing of FIG. 6 in longitudinal cross section;

FIG. 9 illustrates an end of the inner housing of FIG. 6 view along the X-axis;

FIG. 10 illustrates the inner housing of FIG. 6 viewed from underneath in the direction of the Y-axis;

FIG. 11 illustrates a perspective view of the outer and inner housing operatively connected to form a hinged joint according to the present invention in an open condition and holding two frame members in co-linear arrangement in the direction of the X-axis;

FIG. 12 illustrates the open hinged joint of FIG. 11 from the side, viewed in the direction of the Z-axis;

FIG. 13 illustrates the open hinged joint of FIG. 11 in longitudinal cross section;

FIG. 14 illustrates the hinged joint of the present invention in perspective view just after it has been cracked, that is, the condition of the joint has just been changed from the fully open condition to partially closed;

FIG. 15 illustrates the cracked position hinged joint of FIG. 14 viewed from the side in the direction of the Z-axis;

FIG. 16 illustrates the cracked hinged joint of FIG. 14 in longitudinal cross section;

FIG. 17 illustrates the hinged joint of the present invention in perspective view when in the fully folded position;

FIG. 18 illustrates the folded hinged joint of FIG. 17 from the side, viewed in the direction of the Z-axis;

FIG. 19 illustrates the fully closed hinged joint of FIG. 17 viewed from underneath in the direction of the Y-axis;

FIG. 20 illustrates motion of the hinge pin within the hinge pin guide from the open joint condition (FIG. 20A) to the cracked hinged joint condition (FIG. 20B) to the folded joint condition (FIG. 20B).

### DETAILED DESCRIPTION

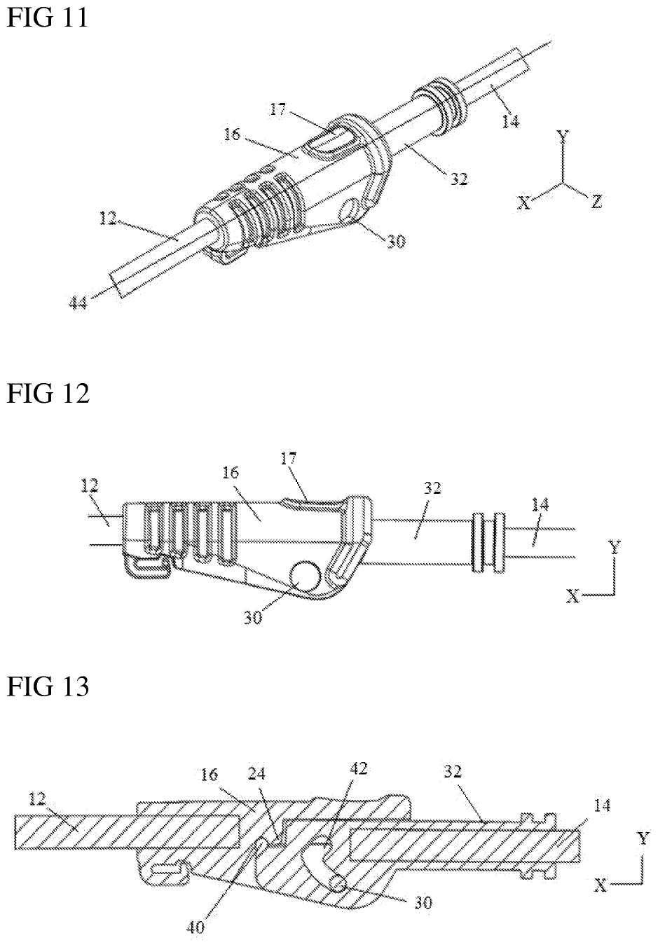

For purposes of description herein, the terms “upper,” “lower,” “right,” “left,” “rear,” “front,” “vertical,” “horizontal,” “interior,” “exterior,” “longitudinal”, “transverse” and derivatives thereof shall relate to the invention as oriented in FIG. 11. The axes labelled x, y and z in the figures all relate to, and are consistent with this orientation. In particular the term “longitudinal” with reference to the drawings indicates a direction parallel or co-axial with the X-axis in the figures, and the term “transverse” indicates a direction parallel or co-axial with the Z-axis in the figures.

However, it is to be understood that the invention may assume various alternative orientations, except where expressly specified to the contrary. It is also to be understood that the specific devices and processes illustrated in the attached drawing and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature or component extending in or along a given direction or the like does not mean that the feature or component follows a straight line or axis in such a direction or that it only extends in such direction or on such a plane without other directional components or deviations, unless otherwise specified.

List of Parts

| | | | |
|---|---|---|---|
| | | 10 | hinged joint |
| | | 12 | outer housing frame member |
| | | 14 | inner housing frame member |
| | | 16 | outer housing |
| 17 | pressure point | 18 | outer housing channel |
| | | 20 | elongate seat |
| 21 | operably right side wall | 22 | operably left side wall |
| | | 24 | hook-receiving shoulder |
| 25 | operably left locking recess | 26 | operably right locking recess |
| 27 | operably left pivot mounting | 28 | operably right pivot mounting |
| | | 30 | hinge pin |
| | | 32 | elongate inner housing |
| 33 | operably left hinge pin end | 34 | operably right hinge pin end |
| | | 38 | body of inner housing |
| | | 40 | hook |
| 41 | locking guide part of the pin | 42 | hinge pin guide |
| | guide | | |
| 43 | unlocking guide part of the pin | 44 | longitudinal axis |
| | guide | | |
| 45 | operably left locking lug | 46 | operably right locking lug |
| | | 48 | inner housing channel |

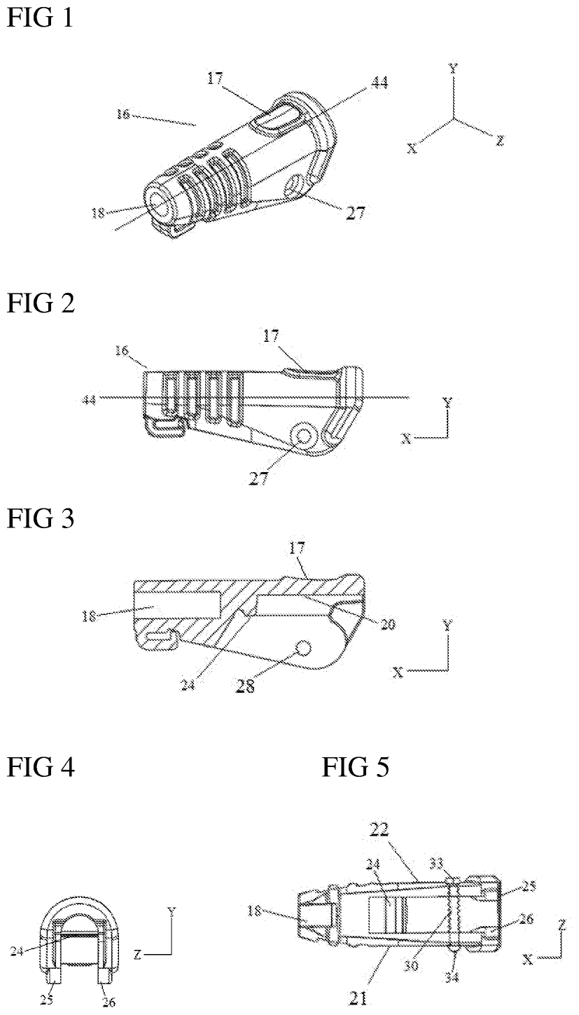

FIG. 1 to FIG. 5 illustrate various aspects of the outer housing 16 in perspective view (FIG. 1), in side view (FIG. 2), in longitudinal cross section (FIG. 3), end view (FIG. 4) and underneath view (FIG. 5).

The perspective view of FIG. 1 shows the exterior of the outer housing 16, including the opening for the outer housing channel 18. The outer housing channel 18 is substantially parallel to the longitudinal axis 44 which corresponds to the X-axis indicated in the figure.

The cross-sectional view of FIG. 3 clearly shows the outer housing channel 18 which is adapted for receiving an outer housing frame member 12 (not shown in this view) which can be held by interference fit. The outer housing 16 is generally elongate having a longitudinal axis in the X-axis direction and includes a seat 20 which is elongate in the X-axis direction. At one end of the seat is a hook-receiving shoulder 24 that is elongate in the Y-axis direction.

This is more clearly illustrated in FIG. 5 which shows the operably right side wall 21 and operably left side walls 22 with the hook-receiving shoulder 24 extending transversely therebetween. The reference to ‘left’ and ‘right’ indicates the positions of the walls on either side (in the z-axis direction) of the longitudinal axis. At the other end of the operably right and operably left side walls 21, 22, are respective operably right and left locking recesses 25, 26. The operably right and left locking recesses 25, 26 are more clearly apparent in the end view of the outer housing 16 as shown in FIG. 4.

An operably right pivot mounting 28 and an operably left pivot mounting 27 are disposed on the operably right side wall 21 and the operably left side wall 22, respectively. FIG. 5 illustrates a hinge pin 30 having an operably left end 33 located in the operably left pivot mounting 28, and an operably right end 34 located in the operably right pivot mounting 27 such that the hinge pin 30 is transverse to the longitudinal axis 44 of the outer housing 16.

The hinge pin 30 may be any convenient fastener having an elongate body such as a rivet, a screw or a bolt. In a particularly preferred embodiment, the hinge pin 30 is a rivet. In another preferred embodiment the hinge pin 30 is threaded at one or both ends for receiving a nut, such as a hex, cap or square nut. Alternatively, the hinge pin 30 may have an integral head, such as a flat, oval, round, pan, hex, hex washer, button or socket head. In the embodiment depicted in FIG. 5 the hinge pin 30 is a round head screw having a hex nut at the other end.

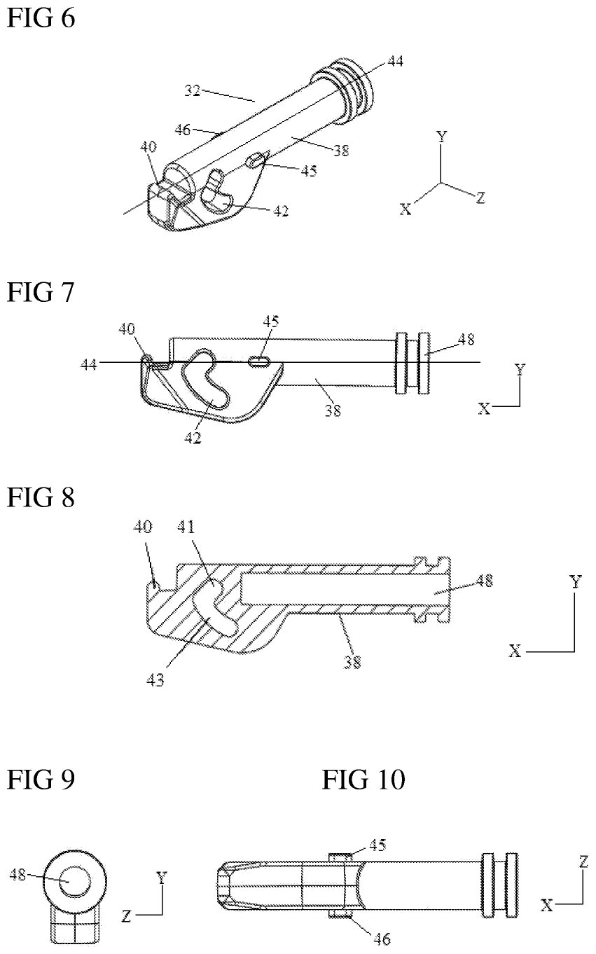

FIG. 6 to FIG. 10 illustrate various aspects of the inner housing 32 in perspective view (FIG. 6), in side view (FIG. 7), in longitudinal cross section (FIG. 8), in end view (FIG. 9) and from underneath (FIG. 10).

As shown at least in FIG. 6 and FIG. 7 the inner housing 32 has a longitudinal axis 44. A hook 40 is formed adjacent an end of the inner housing 32, the hook being adapted to be received on the shoulder 24 of the outer housing 16 as illustrated in at least FIG. 3 and FIG. 5.

A hinge pin guide 42 in the form of a recess or aperture passes transversely, in the Z-direction through the body of the inner housing 32. The hinge pin guide 42 has a first guide part which in this embodiment is, a locking guide part 41 in communication with a second guide part, which in this embodiment is an unlocking guide part 43. As seen in FIG. 8 showing the longitudinal cross section in the X-Y plane, the locking guide part 41 and unlocking guide part 43 form a hinge guide 42 that is generally L- or V-shaped. In this view, each of the locking guide part 41 and unlocking guide part 43 of the hinge pin guide are generally linear and disposed at an angle relative to the longitudinal axis 44.

A left locking lug 45 and an operably right locking lug 46 are disposed on the outer surface 38 of the inner housing 32. The locking lugs 45, 46 are transversely disposed, projecting from either side of the inner housing 32. The locking lugs 45, 46 are configured to be at least partially received in corresponding locking recess 25, 26 of the outer housing 16.

When the hinged joint 10 is moved into the open condition, the locking lugs 45, 46 each slide along ramp (not shown) inside the outer housing 16 and drops into a corresponding locking recess 25, 26. The ramps are profiled to aid a seamless movement without impairing the movement of the hinged joint 10 between the folded and unfolded condition. The locking lugs 45,46 longitudinally align the outer housing 16 and inner housing 32 to ensure the hinged joint 10 correctly drops into its locked condition.

FIG. 8 clearly shows the inner housing channel 48 into which an inner housing frame member 14 may be received, the opening for the inner housing channel 48 being clearly shown in the end view of FIG. 9. The inner housing channel 48 is substantially parallel to the longitudinal axis 44 which corresponds to the X-axis indicated in the figure.

FIGS. 11 to 13 illustrate the hinged joint 10 of the present invention in the open condition in perspective view (FIG. 11), side view (FIG. 12) and in longitudinal cross section (FIG. 13). The outer housing frame member 12 and inner housing frame member 14 are shown respectively located in the outer housing channel 18 of the outer housing 16 and the inner housing channel 48 of the inner housing 32. The outer housing frame member 12, inner housing frame member 14, outer housing 16 and the inner housing 32 are substantially aligned along the longitudinal axis 44. The locking lugs 45,46 longitudinally align the outer housing 16 and inner housing 32 to ensure the hinge joint has correctly dropped into the locked condition.

The longitudinal cross-section view of FIG. 13 clearly shows how the outer housing 16 is located in the elongate seat of the inner housing 32 and the two housings are interconnected by the hinge pin 30. In this arrangement, the hook-receiving shoulder 24 of the outer housing 16 engages the hook 40 of the inner housing 32. The locking lugs 45, 46 engage the corresponding locking recesses 25, 26.

The ends of the hinge pin 30 are received in the operably right pivot mounting 28, operably left pivot mounting and the hinge pin guide 42. The body of the hinge pin 30 is located in the locking guide part 41 of the hinge pin guide 42.

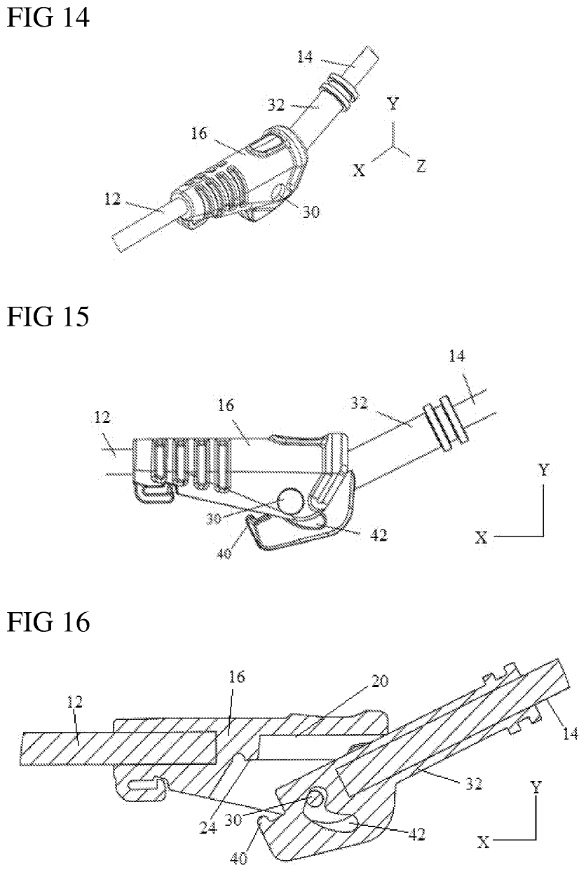

FIGS. 14 to 16 illustrate the hinged joint of the present invention just after it has been ‘cracked’ from the fully open condition, that is the inner housing 32 has been rotated slightly in the X-Y plane. The cracked hinged joint 10 is shown in perspective view (FIG. 14), in side view (FIG. 15) and in longitudinal cross-section (FIG. 16). The outer housing frame member 12 and outer housing 16 form an obtuse angle in the X-Y plane with the inner housing 32 and inner housing frame member 14.

Specifically, the hinged joint 10 has been opened by the user applying manual pressure, such as thumb pressure, to the outer housing 16 at pressure point 17, applying pressure transversely toward the inner housing 32 to cause the hinge pin 30 to slide within the locking guide part 41 towards the unlocking guide part 42. This confluence of the locking guide part 41 and the unlocking guide part 42 is an angled rest point of the hinge pin guide 42. This position becomes the pivot point to enable the joint 10 to fold in the opposite direction towards the folded condition. The manual pressure causes some flexing in the structure to assist this movement.

Preferably the outer housing 16 and inner housing 32 comprise a resilient flexible material such as a polymer that flexes slightly under manual pressure.

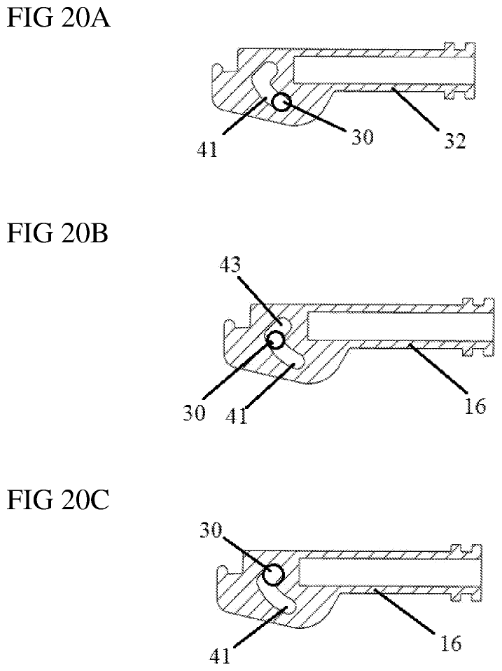

The inner housing 32 is rotated about the hinge pin 30, disengaging the hook 40 from the hook receiving shoulder 24, and snapping locking lugs 45, 46 out of engagement with their corresponding locking recess 25, 26 and along the corresponding ramps. The motion of the hinge pin 30 within the hinge pin guide 42 is further illustrated in cross-sectional view in FIG. 20.

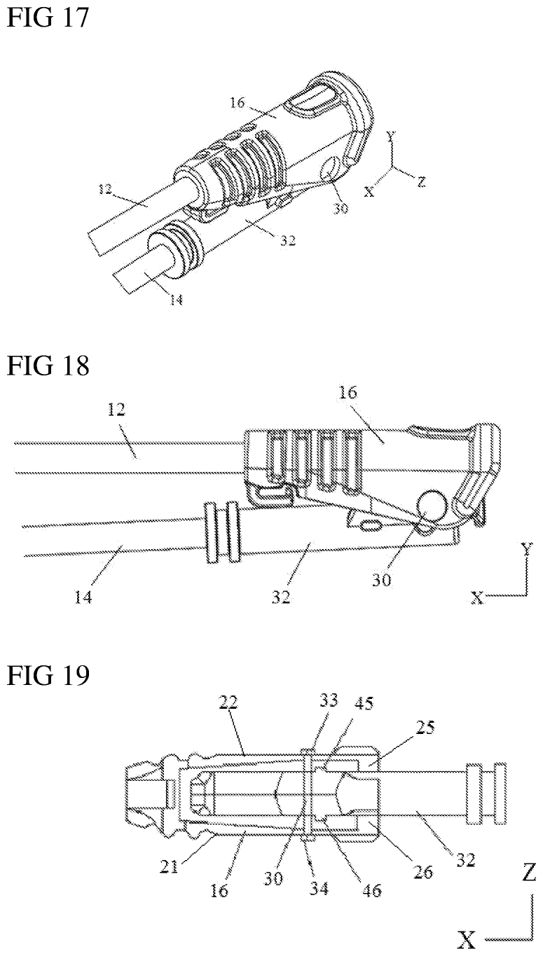

FIG. 17 to FIG. 19 illustrate the hinged joint 10 of the present invention when fully folded in perspective view (FIG. 17), in side view (FIG. 18) and in longitudinal cross section (FIG. 19). In the fully folded position, the outer housing frame member 12 and outer housing 16 are substantially parallel with the inner housing 32 and inner housing frame member 14.

Specifically, the hinged joint 10 has been fully closed by the user rotating the inner housing 32 about the hinge pin 30. The hinge pin 30 is now located in the unlocking guide part 43 of the hinge pin guide 42. The motion of the hinge pin 30 within the hinge pin guide 42 is further illustrated in cross-sectional view in FIG. 20.

The hinged joint 10 may be readily moved opened again by rotation of the inner housing 32 in the opposite direction about the hinge pin 30, moving the hinge pin 30 from the unlocking guide part 43 of the pin guide 42 into the locking guide part 41 of the pin guide 42. In this arrangement, the hook 40 of the outer housing 16 can be received onto the shoulder 24 of the inner housing 32. The locking lugs 45, 46 can slide along their respective ramps on the inside of the outer housing 16 and be snapped into the corresponding locking recesses 25, 26, thus longitudinally aligning the outer housing 16 and inner housing 32 and ensuring that the hinge joint correctly drops into its locked condition.

FIG. 20 illustrates motion of the hinge pin 30 within the hinge pin guide 42 from the open joint condition (FIG. 20A) to the cracked hinged joint condition (FIG. 20B) to the folded joint condition (FIG. 20B). FIG. 20B illustrates the hinge pin 30 at the angled rest point of the pin guide where the locking guide part 41 of the hinge guide 42 meets the unlocking guide part 43 of the hinge guide 42. This position becomes the pivot point enabling the hinge joint to fold back in the opposite fold down direction.

While this invention has been described in connection with specific embodiments thereof, it will be understood that it is capable of further modification(s). This application is intended to cover any variations uses or adaptations of the invention following in general, the principles of the invention and including such departures from the present disclosure as within known or customary practice within the art to which the invention pertains and as may be applied to the essential features hereinbefore set forth.

As the present invention may be embodied in several forms without departing from the spirit of the essential characteristics of the invention, it should be understood that the above-described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

Whenever a range is given in the specification, all intermediate ranges and subranges, as well as all individual values included in the ranges given are intended to be included in the disclosure. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term “comprising” is intended to encompass the narrower “consisting essentially of” and the even narrower “consisting of.” Thus, in any recitation herein of a phrase “comprising one or more claim element” (e.g., “comprising A), the phrase is intended to encompass the narrower, for example, “consisting essentially of A” and “consisting of A”. Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

Each reference cited herein is incorporated by reference herein in its entirety. Such references may provide sources of materials; alternative materials, details of methods, as well as additional uses of the invention.

1. A hinged joint for connecting an outer housing frame member to an inner housing frame member, the hinged joint comprising:
an outer housing associated with the outer housing frame member, the outer housing having an elongate seat disposed between opposing side walls, and a hinge pin supported by each of said side walls;
an inner housing associated with an inner housing frame member, the inner housing being at least partially receivable on the elongate seat of the outer housing, the hinge pin being operatively locatable in a hinge pin guide of the inner housing, the hinge pin guide having a locking guide part and an unlocking guide part,
wherein movement of the outer housing is in association with movement of the hinge pin in the hinge guide of the inner housing.

2. A hinged joint for connecting a first frame member to a second frame member, the hinged joint comprising:
a first housing associated with the first frame member, the first housing having an elongate seat disposed between opposing side walls, and a hinge pin supported by each of said side walls;
a second housing associated with a second frame member, the second housing being at least partially receivable on the elongate seat of the first housing, the hinge pin being operatively locatable in a hinge pin guide of the second housing, the hinge pin guide having a first guide part and a second guide part,
wherein movement of the first housing is in association with movement of the hinge pin in the hinge guide of the second housing.

3. A hinged joint according to claim 1 wherein the hinge pin guides form a generally L-shaped, V-shaped or C-shaped arcuate hinge pin guide.

4. A hinged joint for connecting an outer housing frame member to an inner housing frame member, the hinged joint having:
(a) an outer housing comprising;
an outer housing channel for receiving the outer housing frame member,
an elongate seat, the seat having opposed side walls and a hook-receiving shoulder therebetween,
at least one locking recess located adjacent an end of a side wall,
an operably right pivot mounting and an operably left pivot mounting disposed on each of the side walls;
(b) an elongate inner housing having a longitudinal axis and being at least partially receivable on the elongate seat, the inner housing comprising;
an inner housing channel for receiving the inner housing frame member,
a hook adjacent an end of the inner housing, the hook adapted to be received on the shoulder of the outer housing,
a curved hinge pin guide having a locking guide part and an unlocking guide part,
at least one locking lug disposed on an outer surface of the inner housing and configured to be at least partially received in the at least one locking recess of the outer housing; and
(c) a hinge pin receivable in the operably right pivot mounting, operably left pivot mounting and the hinge pin guide when the inner housing is located in the elongate seat of the outer housing, such that the outer housing is operatively jointed to the inner housing.

5. A hinged joint for connecting a first frame member to a second frame member, the hinged joint having:
(a) a first housing comprising;
a first channel for receiving the first frame member,
an elongate seat, the seat having opposed side walls and a hook-receiving shoulder therebetween,
at least one locking recess, preferably located adjacent an end of a side wall,
a first pivot mounting and a second pivot mounting disposed on each of the side walls;
(b) an elongate second housing having a longitudinal axis and being at least partially receivable on the elongate seat, the second housing comprising;
a second channel for receiving the second frame member,
a hook adjacent an end of the second housing, the hook adapted to be received on the shoulder of the first housing,
a curved hinge pin guide having a first guide part and a second guide part,
at least one locking lug disposed on an outer surface of the second housing and configured to be at least partially received in the at least one locking recess of the first housing; and
(c) a hinge pin receivable in the first pivot mounting, second pivot mounting and the hinge pin guide when the second housing is located in the elongate seat of the first housing, such that the first housing is operatively jointed to the second housing.

6. A frame comprising a plurality of frame members,
including at least one pair of elongate frame members in co-axial arrangement and connected by a hinged joint according to claim 1, and
wherein the frame can move between a self-supporting condition in which the hinged joint is in an open condition and a folded condition wherein the hinged joint is in a folded condition and the at least one pair of frame members are folded.

7. A method of moving the jointed hinge according to claim 1 between an open condition and a folded condition, the method comprising the steps of;
applying manual pressure on the outer housing transversely toward the inner housing to cause the hinge pin to slide within the locking guide part towards the unlocking guide part,
rotating the inner housing around the hinge pin to move the hinge pin into the unlocking guide part, disengage the hook from the shoulder of the outer housing, and move the at least one lug out of the at least one locking recess.

8. A method of moving the jointed hinge according to claim 1 between a folded condition and an open condition, the method comprising the steps of;
rotating the inner housing around the hinge pin to slide the hinge pin within the unlocking guide part towards the locking guide part, and
sliding the hinge pin from the unlocking guide part into the locking guide part, to engage the hook on the shoulder of the outer housing and locate the at least one lug in the at least one locking recess.

9. A kit comprising:
(a) an outer housing comprising;
an outer housing channel for receiving the outer housing frame member,
an elongate seat, the seat having opposed side walls and a hook-receiving shoulder therebetween,
at least one locking recess, preferably located adjacent an end of a side wall,
an operably right pivot mounting and an operably left pivot mounting disposed on each of the side walls;
(b) an elongate inner housing having a longitudinal axis and being at least partially receivable on the elongate seat, the inner housing comprising;
an inner housing channel for receiving the inner housing frame member,
a hook adjacent an end of the inner housing, the hook adapted to be received on the shoulder of the outer housing,
a curved hinge pin guide having a locking guide part and an unlocking guide part,
at least one locking lug disposed on an outer surface of the inner housing and configured to be at least partially received in the at least one locking recess of the outer housing; and
(c) a hinge pin receivable in the operably right pivot mounting, operably left pivot mounting and the hinge pin guide when the inner housing is located in the elongate seat of the outer housing, such that the outer housing is operatively jointed to the inner housing;
(d) wherein the outer housing, the elongate inner housing, and the hinge pin are capable of assembly into a hinged joint for connecting an outer housing frame member to an inner housing frame member.
